(19) United States
(12) Patent Application Publication
(10) Pub. No.: US 2002/0108870 A1
(43) Pub. Date: Aug. 15, 2002

(54) Nitrogen oxide sensor and method for detecting nitrogen oxides

(76) Inventor: Thomas R. Thoreson, Brighton, MI (US)

Correspondence Address: VINCENT A. CICHOSZ, DELPHI TECHNOLOGIES, INC., P.O. Box 5052, Mail Code: 480-414-420, Troy, MI, 48007-5052, US

(21) Appl. No.: 09/735,124

(22) Filed: Dec. 12, 2000

(51) Int. Cl. G01N 27/407

(52) U.S. Cl. 205/781; 204/424; 204/426

(57) ABSTRACT

An exemplary embodiment of a planar exhaust gas sensor for determining the nitrogen oxide concentration in exhaust gas is disclosed herein. The sensing element has a first pumping electrochemical cell, a reference cell, and a second pumping cell arranged so that both oxygen and nitrogen oxide partial pressures in an exhaust gas can be sensed. Nitrogen oxides in an exhaust gas enter the sensing element through a protective material. The nitrogen oxides then diffuse through a first pumping cell, and a porous material. At the pumping electrode of a second pumping cell, the nitrogen oxide is reduced, and the ionic oxygen thereby produced is pumped across a solid electrolyte to a second inner electrode. A measured current produced in a second pumping cell circuit is directly proportional to the nitrogen oxides in the exhaust gas.

### TECHNICAL FIELD

This invention relates generally to gas sensors, and, more particularly, to nitrogen oxides and oxygen sensors.

### BACKGROUND OF THE INVENTION

Oxygen sensors are used in a variety of applications that require qualitative and quantitative analysis of gases, and frequently depend on similar electrochemical reactions. A conventional stoichiometric oxygen sensor typically consists of an ionically conductive solid electrolyte material, a porous catalytic electrode having a porous protective overcoat on the sensor's exterior, which is exposed to the exhaust gases, and a porous electrode on the sensor's interior surface, which is exposed to a known oxygen concentration. The known oxygen concentration is typically ambient air or a pumped air reference. Sensors typically employed in automotive applications use a yttria-stabilized, zirconia-based electrochemical galvanic cell operating in potentiometric mode to detect the relative amounts of oxygen present. When opposite surfaces of this galvanic cell are exposed to different oxygen partial pressures, an electromotive force is developed between the electrodes on the opposite surfaces of the zirconia electrolyte, according to the Nernst equation:

$$E = ( \frac{RT}{4 F} ) ln ( \frac{{( {P}_{{O}_{2}} )}_{ref}}{( {P}_{{O}_{2}} )} )$$

where: E=electromotive force

R=universal gas constant

F=Faraday constant

T=absolute temperature of the gas

(P_{O2})_{ref}=oxygen partial pressure of the reference gas

(P_{O2})=oxygen partial pressure of the exhaust gas

Conventional nitrogen oxide sensors, however, have several drawbacks including complicated aperture-cavity designs that employ multiple gas pumping chambers interconnected via one or more orifices, a complex set of gas passageways, and solid conductive electrolyte material, which does not allow gas to diffuse through it.

Consequently, there exists a need for a sensor element that is capable of sensing nitrogen oxides without the need for complex porting and structure.

### BRIEF SUMMARY OF THE INVENTION

The drawbacks and disadvantages of the prior art are overcome by the exemplary embodiment of a gas sensor element and its method for sensing nitrogen oxides in a gas, and measuring concentrations of oxygen and nitrogen oxides. The gas sensor element comprises: a first pumping cell comprising an outer electrode and a first pumping electrode, between which is disposed a porous electrolyte in a first dielectric layer; a porous material disposed in a third dielectric layer, and in fluid communication with the first pumping cell; a reference cell a first inner electrode and a reference electrode, between which is disposed a first solid electrolyte disposed in a fourth dielectric layer, wherein the first inner electrode is disposed in fluid communication with the porous material opposite the first pumping electrode; and a second pumping cell comprising a second pumping electrode and a second inner electrode, between which is disposed a second solid electrolyte disposed in the fourth dielectric layer, wherein the second pumping electrode is disposed in fluid communication with the porous material on a side opposite the first pumping electrode.

The method for sensing nitrogen oxides in a gas comprises: applying a potential to a first pumping cell, diffusing the gas through a first pumping cell, removing molecular oxygen from the gas, generating a current in the first pumping cell, diffusing the gas through a porous material, applying a potential to a second pumping cell, reducing nitrogen oxides in the gas to form oxygen ions, pumping the oxygen ions within to a second inner electrode, generating a current in the second pumping cell, and measuring the current in the second pumping cell.

The method for measuring both nitrogen oxides and oxygen concentrations in an gas comprises diffusing the gas through a first pumping cell and applying a first potential to the first pumping cell to ionize oxygen in the gas. A plurality of first oxygen ions, generated at the first pumping cell, are pumped therethrough, generating a first current. The gas is also diffused through a porous material disposed in fluid communication with the first pumping cell to a reference cell and a second pumping cell. The pressure of oxygen in the gas at the reference cell is determined to control the first potential. A second potential is applied to the second pumping cell to reduce nitrogen oxides and produce second oxygen ions which are pumped to a second inner electrode, generating a second current. The second current is measured. The first current is used to determine an oxygen concentration, and the second current is used to determine a nitrogen oxide concentration.

The above-described and other features and advantages of the present invention will be appreciated and understood by those skilled in the art from the following detailed description, drawings, and appended claims.

### BRIEF DESCRIPTION OF THE DRAWINGS

For a further understanding of the nature of the present invention, as well as other features and advantages thereof, reference should be made to the following detailed description taken in conjunction with the accompanying drawing, which is meant to be exemplary not limiting.

FIG. 1 is an exploded view of an exemplary embodiment of an exhaust gas sensor element.

### DETAILED DESCRIPTION OF THE INVENTION

A gas sensor element is described herein, wherein a sensor element has an electrochemical cell for reducing nitrogen oxides, thereby producing oxygen ions that create a measurable current that is directly proportional to the nitrogen oxide concentration in a gas. It is hereby understood that although the apparatus and method are described in relation to making a nitrogen oxide sensor, the sensor could be an oxygen sensor, a hydrocarbon sensor, a sulfur oxides sensor, and the like, for use with gas detection equipment in smokestacks, chimneys, furnaces, smelting equipment, an automotive exhaust system, handheld monitoring devices, and the like. For purposes of illustration and example, the gas sensor element described herein is configured for sensing nitrogen oxide and oxygen concentrations in exhaust gas.

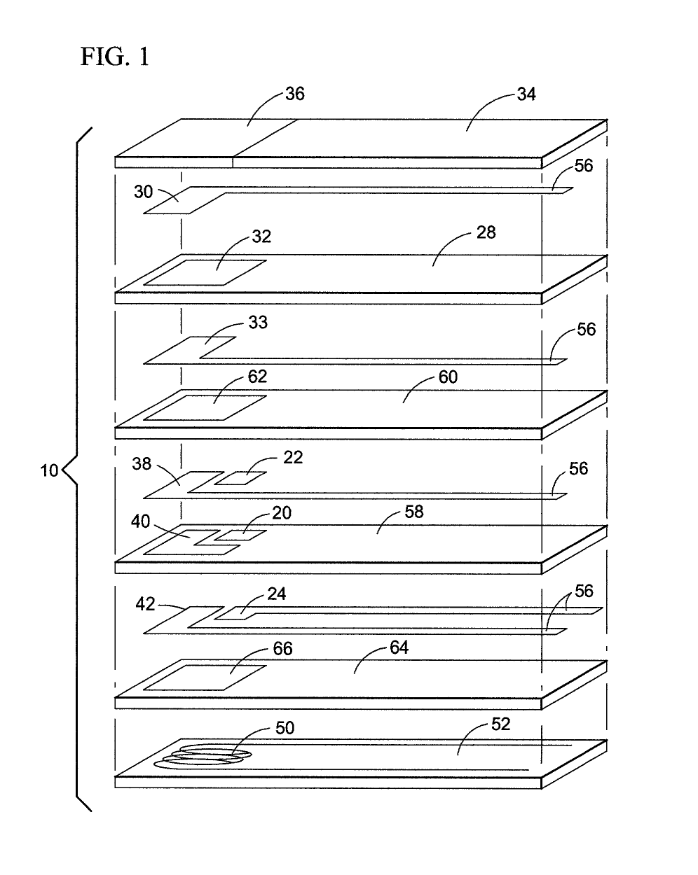

FIG. 1 shows an exemplary embodiment of a sensor element having a plurality of dielectric layers arranged parallel to one another, and in physical contact. The sensor element 10 comprises a porous electrolyte 32 disposed through a first dielectric layer 28 and between and in electrical contact with an outer electrode 30 and a first pumping electrode 33. A porous protective material 36 is disposed in contact with the porous electrolyte 32, the outer electrode 30, and a second dielectric layer 34, wherein the second dielectric layer 34 is disposed in contact with the first dielectric layer 28. A porous material 62 is disposed through a third dielectric layer 60, wherein the porous material 62 is disposed in fluid communication with the first pumping electrode 33, and in contact with the third dielectric layer 60 which is disposed on a side of the first dielectric layer 28 opposite the second dielectric layer 34.

The sensor element further comprises a first solid electrolyte 20 disposed between a first inner electrode 22 and a reference electrode 24 and through a fourth dielectric layer 58, wherein the fourth dielectric layer 58 is disposed in contact with the third dielectric layer 60 on a side opposite the first dielectric layer 28. A second solid electrolyte 40 is disposed between a second inner electrode 42 and a second pumping electrode 38, and in the fourth dielectric layer 58. A porous oxygen storage 66 is disposed in fluid communication with the second inner electrode 42 and the reference electrode 24, and within a fifth dielectric layer 64, wherein the fifth dielectric layer 64 is in contact with the fourth dielectric layer 58. The sensor element can further comprise a plurality of leads 56 extending from each of the electrodes 30, 33, 38, 22, 42, 24, as well as one or more additional dielectric layers 52 in which an electrical resistance heater 50, ground plane (not shown), and/or other conventional sensor components can be disposed.

The electrodes and electrolytes form electrochemical cells. The outer electrode 30, porous electrolyte 32, and first pumping electrode 33 form a first pumping cell (30/32/33), the first inner electrode 22, first solid electrolyte 20, and reference electrode 24 form a reference cell (22/20/24), and the second pumping electrode 38, second solid electrolyte 40 and second inner electrode 42 form a second pumping cell (38/40/42).

The exhaust gas, possibly containing oxygen and nitrogen oxides, enters the first pumping cell (30/32/33) through the porous protective material 36, and diffuses through the outer electrode 30 and porous electrolyte 32 to the first pumping electrode 33. The nitrogen oxide and oxygen sensor is a diffusion limited sensor, and, as such, does not need to have exhaust gas or reference gas moved into the sensor through any apertures or gas passageways. That is, any gas entering the sensor through the porous protective material 36 will reach the first pumping cell (30/32/33). Likewise, any gas that has diffused through the protective material 36 and first pumping cell (30/32/33) will reach the second pumping cell (38/40/42) and the reference cell (22/20/24). This configuration greatly simplifies the design of the sensor element, and eliminates the need for various ports and gas passageways used in conventional sensors.

A potential applied to the first pumping cell (30/32/33) ionizes the molecular oxygen of the exhaust gas at the first pumping electrode 33. The oxygen ions are pumped through the cell, which results in a very low oxygen partial pressure at the pumping electrode 33. Oxygen remaining at the pumping electrode 33 then diffuses through the porous material 62. The oxygen diffuses and contacts the first inner electrode 22, where the reference cell (22/20/24) functions to compare the partial pressure of oxygen at the inner electrode 22 with a known oxygen partial pressure at the reference electrode 24. The reference electrode 24 determines the known oxygen partial pressure from the oxygen content in the oxygen storage 66. The potential developed across the reference cell (22/20/24) is measured and used to determine the potential that should be applied to the first pumping cell (30/32/33) to maintain a known and very low oxygen partial pressure within the porous material 62 and at the first pumping electrode 33. The measured current in the first pumping cell (30/32/33) circuit will be directly proportional to the partial pressure of oxygen in the exhaust gas.

Meanwhile, the exhaust gas, less the molecular oxygen removed by the first pumping cell, diffuses through the porous material 62 and contacts the second pumping electrode 38, where oxygen ions are produced via the catalytic reduction of the nitrogen oxides. Due to a potential applied to the second pumping cell (38/40/42), the oxygen ions are pumped through the second solid electrolyte 40 to the second inner electrode 42, thereby creating a current in the second pumping cell (38/40/42) circuit that is proportional to the partial pressure of nitrogen oxides in the exhaust gas. The sensor element shown in FIG. 1, therefore, can quantify both the amount of oxygen and nitrogen oxides present in the exhaust gas.

The position of the second pumping cell (38/40/42) relative to the reference cell (22/20/24) as shown in FIG. 1 is not fixed. Various arrangements of the first solid electrolyte 20 and the second solid electrolyte 40 in the fourth dielectric layer 58, and their associated electrodes, can be used to achieve similar results.

The first and second solid electrolyte layers 20, 40 can be any material that is capable of permitting the electrochemical transfer of oxygen ions while inhibiting the physical passage of exhaust gases. The electrolyte material also possesses an ionic/total conductivity ratio of approximately unity, and is compatible with the environment in which the sensor will be utilized (e.g., temperatures up to about 1,000° C.). Possible solid electrolyte materials include conventional materials, including, but not limited to, metal oxides such as zirconia, and the like, which may optionally be stabilized with calcium, barium, yttrium, magnesium, aluminum, lanthanum, cesium, gadolinium, and the like, as well as oxides, alloys, and combinations comprising at least one of the foregoing electrolyte materials. Typically, the solid electrolyte has a thickness of up to about 500 microns, with a thickness of about 25 microns to about 500 microns preferred, and a thickness of about 50 to about 200 microns especially preferred.

As with the solid electrolytes 20, 40 the porous electrolyte 32 makes use of an applied electrical potential to influence the movement of oxygen. The porous electrolyte 32 should be capable of permitting the physical migration of exhaust gas and the electrochemical movement of oxygen ions, and should be compatible with the environment in which the sensor is utilized. Typically, the porous electrolyte 32 has a porosity of up to about twenty percent, with a median pore size of up to about 0.5 microns, or, alternatively, comprises a solid electrolyte having one or more gas passageways (one or more holes, slits, apertures, or the like, as well as combinations comprising at least one of the foregoing passageways) therein, so as to enable the physical passage of exhaust gases. Commonly assigned U.S. Pat. No. 5,762,737 to Bloink et al., which is hereby incorporated in its entirety by reference, further describes possible embodiments of porous electrolytes and materials for their use. Possible porous electrolyte materials include those listed above for the solid electrolyte 20, 40. Typically, the porous electrolyte 32 has a thickness of up to about 500 microns, with a thickness of about 25 microns to about 500 microns preferred, and a thickness of about 50 to about 200 microns especially preferred.

The electrolytes 32, 20, 40 can be formed via many conventional processes including, but not limited to, die pressing, roll compaction, stenciling and screen printing, combinations comprising at least one of the foregoing, and the like. For improved process compatibility, it is preferred to utilize a tape process using known ceramic tape casting methods. The first solid electrolyte 20, and the second solid electrolyte 40 can be formed from the same or different materials.

The outer electrode 30, first pumping electrode 33, and first inner electrode 22, can comprise any catalyst capable of ionizing oxygen while not significantly reducing nitrogen oxides, including, but not limited to, platinum, palladium, gold, osmium, rhodium, iridium, ruthenium, zirconium, yttrium, cerium, calcium, aluminum, and the like, as well as alloys, oxides, and combinations comprising at least one of the foregoing catalysts. The outer electrode 30, first pumping electrode 33, and first inner electrode 22 preferably comprise a gold, platinum, or gold/platinum mixture, or other suitable alloys which inhibit the reduction of nitrogen oxides at these electrodes.

Reference electrode 24 and second inner electrode 42 can also comprise any catalyst capable of ionizing oxygen, including, but not limited to, platinum, palladium, gold, osmium, rhodium, iridium, ruthenium, zirconium, yttrium, cerium, calcium, aluminum, and the like, as well as alloys, oxides, and combinations comprising at least one of the foregoing catalysts. The electrodes 30, 33, 22, 24, 42 can comprise different material. For example, electrodes 22, 30, and 33, can comprise gold and/or platinum, electrodes 24 and 42 can comprise platinum and/or palladium, and electrode 38 can comprises rhodium.

The electrodes 30, 33, 22, 24, 42 preferably have a porosity sufficient to permit the diffusion of oxygen molecules without substantially restricting such gas diffusion. Typically, the porosity of the electrodes 30, 33, 22, 24, 42 is greater than the porosity of the porous electrolyte 32.

The second pumping electrode 38 can comprise any material that is capable of catalyzing the reduction of nitrogen oxides to form ionic oxygen, such as, e.g., rhodium, platinum, and the like, alloys including rhodium and one or more precious metals, including mixtures and alloys comprising at least one of these materials, with a rhodium and platinum alloy preferred. The material also preferably permits the diffusion of oxygen molecules without substantially restricting such gas diffusion. To allow such diffusion the porosity of the second pumping electrode 38 is typically greater than the porosity of the porous electrolyte 32.

Typically, the size and geometry of all of the electrodes 30, 33, 22, 24, 42, 38 are adequate to provide current output sufficient to enable reasonable signal resolution over a wide range of air/fuel ratios. Generally, a thickness of about 1 to about 25 microns can be employed, with a thickness of about 5 to about 20 microns preferred, and about 10 to about 18 microns more preferred. Although any size and geometry can be employed, the geometry of the electrodes 30, 33, 22, 24, 42, 38 is generally substantially similar to the geometry of the corresponding electrolyte. The electrodes are preferably larger than the electrolytes to ensure the electrodes cover the electrolytes, prevent leakage between the electrolytes, and have sufficient print registration tolerance.

The electrodes 30, 33, 22, 24, 42, 38 can be formed using conventional techniques such as sputtering, chemical vapor deposition, screen printing, stenciling, combinations comprising at least one of the foregoing techniques, and the like, with screen printing the electrodes onto appropriate tapes preferred due to simplicity, economy, and compatibility with the subsequent co-fired process. For example, reference electrode 24 can be screen printed onto the solid electrolyte 20 and dielectric layer 58. Likewise, the first inner electrode 22 can be screen printed onto the solid electrolyte 20, and fourth dielectric layer 58 or porous material 62. The electrode leads 56 and vias (not shown) disposed in the dielectric layers are typically formed simultaneously with the electrodes, and provide electrical connections to the cells from the exterior of the sensor element. Both electrodes 38 and 22 can be electrically connected to and use the same lead 56.

The porous oxygen storage 66 comprises a cavity formed beneath the second inner electrode 42 and the reference electrode 24 in the adjacent fifth dielectric layer 64. This space can be formed by depositing a fugitive material (e.g., carbon based material, plastic, and the like) and optionally and oxygen storage material, on layer 64 in the area in which the storage 66 is desired such that, upon processing, the fugitive material bums out and leaves a cavity which is optionally partially or wholly filled with oxygen storage material. Alternatively, an air reference channel (not shown) can be formed within or between one or more dielectric layers to transport ambient air to the reference electrode 24 and second inner electrode 42. Oxygen is pumped into the porous oxygen storage 66 by maintaining a small pumping current across the reference cell (22/20/24) and from the oxygen pumped through the second pumping cell (38/40/42).

The porous electrolyte 32, first solid electrolyte 20, second solid electrolyte 40, porous material 62, and protective material 36 can be disposed as inserts in holes, slits or apertures, through layers 28, 58, 60, 64, 34 (e.g., see porous electrolyte 32) or disposed adjacent to the layers (e.g., see protect material 36). This arrangement eliminates the use of excess porous electrolyte, solid electrolyte, oxygen storage material, porous material, and protective material, and reduces the size of the sensor by eliminating additional layers. Furthermore, any shape can be used for the porous electrolyte 32, solid electrolytes 20, 40, oxygen storage 66, porous material 62, and protective material 36, since the size and geometry of the various inserts are dependent upon the desired size and geometry of the adjacent electrodes. The geometry can include, but is not limited to, circular, oval, quadrilateral, rectangular, and polygonal, among others.

Dielectric layers 28, 34, 52, 58, and 64, comprise dielectric materials that separate various components, effectively protect and electrically insulate all or a substantial portion of the sensor, as well as provide structural integrity to the sensor. Additional dielectric layers 52 electrically isolate the heater element from the sensor circuits, while the layers 34 and 52 physically cover the outer electrode 30, lead 56, and heater element 50, respectively, to provide physical protection against, e.g., abrasion, and to electrically isolate these components from the packaging. The dielectric layers preferably comprise material having substantially equivalent coefficients of thermal expansion, shrinkage characteristics, and chemical compatibility, to at least minimize, if not eliminate, delamination and other processing problems. These dielectric layers, which can have a thickness of up to about 200 microns thick, with a thickness of about 50 to about 200 microns preferred, can comprise a metal oxide, such as alumina, and the like, as well as mixtures and alloys comprising alumina.

As with the solid and porous electrolytes, the dielectric layers 58, 38, 64, 34, 52 can be formed using ceramic tape casting methods and/or other methods such as plasma spray deposition, screen printing, stenciling, combinations comprising at least one of the foregoing methods, and others conventionally used in the art.

The porous material 62 disposed in layer 60 serves to electrically isolate the first pumping cell (30/32/33) from the second pumping cell (38/40/42) and the reference cell (22/20/24), while providing a porous medium through which nitrogen oxides and oxygen can diffuse to reach the second pumping cell (38/40/42) and the reference cell (22/20/24). Any material that functions in that manner, such as, e.g., porous alumina, can be used.

Typically disposed between two of the additional dielectric layers 52 is an electrical resistance heater 50 and a ground plane (not shown). The heater can be any conventional heater capable of maintaining the sensor end of the element at a sufficient temperature to facilitate the various electrochemical reactions taking place therein. Typically the heater, which is disposed in thermal communication with one or more of the electrochemical cells and is preferably comprised of platinum or palladium, or alloys comprising at least one of the foregoing metals, or any other conventional material, is generally screen printed onto one of the additional dielectric layers 52 to a thickness of about 5 to about 50 microns.

Leads 56 are disposed across various dielectric layers to electrically connect the external wiring of the sensor with electrodes 30, 33, 22, 24, 38, 42. The leads 56 are typically formed on the same layer as the electrode to which they are in direct electrical communication. The leads 56 extend from the electrode to the terminal end of the element, where they are in electrical communication with a corresponding via (not shown). The heater also has leads that are in electrical communication with vias (not shown). At the terminal end of the element, the vias are formed as holes, slits or apertures, and the like, filled with electrically conductive material in the appropriate layers. The vias are typically filled during formation of the electrodes 30, 33, 38, 42, 22, 24 and leads 56, and serve to provide a mechanism for electrically connecting the leads 56 and heater to the exterior of the exhaust gas sensor element. The vias are in electrical communication with contact pads (not shown), which are formed on the exterior surface of the additional dielectric layers 34, 52. The contact pads provide a contact point for the external sensor circuit.

The exemplary gas sensor element described herein simplifies the detection and measurement of nitrogen oxide and oxygen concentrations, and partial pressures of both, in several advantageous ways. First, the gas sensor element does not have a complicated structural design compared to conventional nitrogen oxide sensors. It incorporates a first pumping cell and a second pumping cell, each containing a porous electrolyte material, which allows gas to pump through it without the need for an additional network of gas passageways and orifices. Since gas passageways naturally exist within the porous materials described herein, and the dielectric layers are arranged parallel to one another in physical contact, the gas flows through the exemplary exhaust gas sensor element without additional components and chambers to direct or pump the gas.

Second, the exemplary gas sensor element also advantageously combines a nitrogen oxide sensor with an oxygen sensor. Oxygen sensors determine an oxygen concentration in a gas by measuring the amount of ionized oxygen. Nitrogen oxide sensors determine a nitrogen oxide concentration in a gas by measuring the amount of ionic oxygen present in the reduction of nitrogen oxide. By incorporating a nitrogen oxide sensor into a diffusion limited oxygen sensor, the need for a separate sensor is eliminated. As a result, a simpler and more direct means for measuring both oxygen concentration and nitrogen oxide concentration in exhaust gas, or any type of gas, is provided.

Third, the gas sensor element is more efficient and economical in detecting nitrogen oxide concentration in exhaust gas. The sensor element design effectively combines two different sensors which reduces the cost and labor to install two separate sensors, utilizes space more efficiently in a conventional exhaust system, and eliminates the complexity associated with conventional nitrogen oxide sensor designs.

While preferred embodiments have been shown and described, various modifications and substitutions may be made thereto without departing from the spirit and scope of the invention. Accordingly, it is to be understood that the apparatus and method have been described by way of illustration only, and such illustrations and embodiments as have been disclosed herein are not to be construed as limiting to the claims.

We claim:

1. An exhaust gas sensor element, comprising:
a first pumping cell comprising an outer electrode and a first pumping electrode, between which is disposed a porous electrolyte in a first dielectric layer;
a porous material disposed in a third dielectric layer, and in fluid communication with the first pumping cell;
a reference cell a first inner electrode and a reference electrode, between which is disposed a first solid electrolyte disposed in a fourth dielectric layer, wherein the first inner electrode is disposed in fluid communication with the porous material opposite the first pumping electrode; and
a second pumping cell comprising a second pumping electrode and a second inner electrode, between which is disposed a second solid electrolyte disposed in the fourth dielectric layer, wherein the second pumping electrode is disposed in fluid communication with the porous material on a side opposite the first pumping electrode.

2. The sensor element recited in claim 1, further comprising an electrical resistance heater disposed between at least two dielectric layers and in thermal communication with the second pumping cell.

3. The sensor element recited in claim 1, wherein the first pumping electrode and the first inner electrode are configured to ionize oxygen, the outer electrode is configured to form oxygen molecules, and the second inner electrode and the reference electrode are configured to reduce nitrogen oxides.

4. The sensor element recited in claim 1, wherein the first pumping electrode, the first inner electrode, and the outer electrode further comprise gold or platinum, and the second inner electrode and the reference electrode further comprise platinum or palladium, and the second pumping electrode further comprises rhodium.

5. The sensor element recited in claim 1, wherein the porous electrolyte further comprises a solid electrolyte having a plurality of gas passageways selected from the group consisting of holes, slits, apertures, and combinations comprising at least one of the foregoing passageways.

6. The sensor element recited in claim 1, further comprising a porous gas storage disposed in a fifth dielectric layer, wherein the porous gas storage is disposed in fluid communication with the second inner electrode on a side opposite the second solid electrolyte.

7. The sensor element recited in claim 6, wherein the porous gas storage further comprises a cavity formed beneath the second inner electrode and the reference electrode.

8. The sensor element recited in claim 7, wherein the porous gas storage volume is configured to receive oxygen from the second pumping cell and/or the reference cell.

9. A method for sensing nitrogen oxides in a gas, comprising:
applying a potential to a first pumping cell;
diffusing the gas through a first pumping cell;
removing molecular oxygen from the gas;
generating a current in the first pumping cell;
diffusing the gas through a porous material;
applying a potential to a second pumping cell disposed in fluid communication with the porous material;
reducing nitrogen oxides in the gas to form oxygen ions;
pumping the oxygen ions within to a second inner electrode;
generating a current in the second pumping cell; and measuring the current in the second pumping cell.

10. The method recited in claim 9, further comprising heating the first pumping cell, and the second pumping cell.

11. The method recited in claim 9, further comprising ionizing oxygen at a first pumping electrode and a first inner electrode.

12. The method recited in claim 9, further comprising forming oxygen molecules at an outer electrode of the first pumping cell.

13. The method recited in claim 9, wherein the reducing nitrogen oxides further comprises reducing the nitrogen oxides in the gas to form oxygen ions at a second pumping electrode within the second pumping cell.

14. The method recited in claim 9, wherein the pumping the oxygen ions further comprises pumping the oxygen ions through a second solid electrolyte to a second inner electrode of the second pumping cell.

15. The method recited in claim 9, wherein the removing molecular oxygen further comprises pumping molecular oxygen at a first pumping electrode of the first pumping cell through the first pumping cell.

16. The method recited in claim 15, wherein the pumping further comprises lowering an oxygen partial pressure within the first pumping electrode.

17. The method recited in claim 9, further comprising comparing a partial pressure of oxygen at a first inner electrode of the reference cell with a known oxygen partial pressure at a reference electrode of the reference cell.

18. The method recited in claim 22, further comprising determining the known oxygen partial pressure from the oxygen content in a porous oxygen storage.

19. The method recited in claim 9, wherein the generating the current in the second pumping cell further comprises generating a current proportional to a nitrogen oxide partial pressure.

20. The method recited in claim 9, wherein the generating the current in the first pumping cell further comprises generating a current proportional to an oxygen partial pressure.

21. A method for sensing nitrogen oxides and oxygen concentrations in a gas, comprising:
diffusing the gas through a first pumping cell;
applying a first potential to the first pumping cell to ionize oxygen in the gas;
generating a plurality of first oxygen ions at the first pumping cell;
pumping the first oxygen ions through the first pumping cell;
generating a first current;
diffusing the gas through a porous material disposed in fluid communication with the first pumping cell;
diffusing the gas to a reference cell and a second pumping cell both disposed in fluid communication with the porous material;
determining the pressure of oxygen at the reference cell to control the first potential;
applying a second potential to the second pumping cell to reduce nitrogen oxides and produce second oxygen ions within the second pumping cell;
pumping the second oxygen ions to a second inner electrode;
generating a second current;
measuring the first current and the second current;
determining an oxygen concentration by the first current measurement; and
determining a nitrogen oxide concentration by the second current measurement.

22. The method recited in claim 21, further comprising heating the first pumping cell, the second pumping cell, and the reference cell.

23. The method recited in claim 21, further comprising reducing nitrogen oxides at a second pumping electrode.

24. A gas sensor element, comprising:
a plurality of dielectric layers;
a first pumping cell disposed in the dielectric layers;
a porous material disposed in fluid communication with the first pumping cell; and
a reference cell and a second pumping cell disposed in the same dielectric layer, the reference cell and the second pumping cell disposed in fluid communication with the porous material, on a side of the porous material opposites the first pumping cell, wherein the second pumping cell comprises a nitrogen oxide reducing electrode.

25. The sensor element recited in claim 24, wherein the first pumping cell further comprises an outer electrode and a first pumping electrode, between which is disposed a porous electrolyte.

26. The sensor element recited in claim 24, wherein the reference cell further comprises a first inner electrode and a reference electrode, between which is disposed a first solid electrolyte.

27. The sensor element recited in claim 24, wherein the second pumping cell further comprises a second pumping electrode and a second inner electrode, between which is disposed a second solid electrolyte.

28. The sensor element recited in claim 24, further comprising a porous gas storage disposed in fluid communication with the second pumping cell and the reference cell.

29. The sensor element recited in claim 24, further comprising an electrical resistance heater disposed in on a side of the reference cell opposite the porous material.
